(19) United States
(12) Patent Application Publication
(10) Pub. No.: US 2020/0329734 A1
(43) Pub. Date: Oct. 22, 2020

(54) PROTEIN FOOD PRODUCT

(71) Applicant: ATP Institute Pty Ltd, Springwood (AU)

(72) Inventors: Matthew Legge, Brisbane (AU); Jeff Doidge, Brisbane (AU); John Kapeleris, Brisbane (AU); Toni Doidge, Brisbane (AU)

(73) Assignee: ATP Institute Pty Ltd, Springwood (AU)

(21) Appl. No.: 16/917,409

(22) Filed: Jun. 30, 2020

Related U.S. Application Data
(63) Continuation-in-part of application No. PCT/AU2019/050185, filed on Mar. 5, 2019.

(30) Foreign Application Priority Data
Mar. 5, 2018 (AU) 2018900701
Sep. 26, 2018 (AU) 2018903625
Dec. 7, 2018 (AU) 2018904659
Jul. 30, 2019 (AU) 2019902715

(51) Int. Cl. A23J 3/06; A23L 29/281; A23L 33/15; A23L 33/18; A23L 33/29; A23L 33/175; A23L 33/00; A23P 30/10

(52) U.S. Cl. CPC A23J 3/06; A23L 29/284; A23L 33/15; A23P 30/10; A23L 33/29; A23L 33/175; A23L 33/30; A23L 33/18

(57) ABSTRACT

Provided herein is a protein food product, such as a gummy composition, containing protein that optionally includes collagen protein, peptides and/or one or more amino acids or derivatives thereof, one or more gelling agents and optionally one or more flavouring agents, and/or one or more sweetening agents, in which the total protein content of the food product is at least about 8% by weight and the total lipid content is less than about 60% by weight. Methods of making and using said protein food product are also provided.

### CROSS REFERENCE TO RELATED APPLICATIONS

This is a continuation-in-part of International Application No. PCT/AU2019/050185, filed Mar. 5, 2019, which was published in English under PCT Article 21(2), which in turn claims the benefit of Australia Application No. 2018900701, filed Mar. 5, 2018, Australia Application No. 2018903625, filed Sep. 26, 2018, and Australia Application No. 2018904659, filed Dec. 7, 2018, and this application claims priority to Australian Provisional Application No. 2019902715, filed Jul. 30, 2019, all herein incorporated by reference in their entireties.

### TECHNICAL FIELD

THIS INVENTION relates to a high protein food product, such as a gummy composition, and method of producing the high protein food product.

### BACKGROUND TO THE INVENTION

Protein is a nutrient that is essential to healthy body function. Dietary protein is a source of amino acids including the essential amino acids phenylalanine, valine, threonine, tryptophan, methionine, leucine, isoleucine, lysine, and histidine which cannot be synthesized by the human body. While most healthy diets include numerous different protein sources (e.g. meat, dairy products, eggs, legumes, grains etc) the amount and quality of the protein can vary between these different sources.

Accordingly, food and dietary supplements have been prepared for human consumption that seek to make up for deficiencies in dietary protein or to provide a particular amino acid content or profile designed for a particular purpose, such as sarcopenia prevention and/or treatment, bodybuilding or weight training. However, many of these protein foods and supplements have an unpleasant, artificial taste or include “hidden” calories, sugar alcohols, fats and/or carbohydrates that detract from the nutritional benefit of these foods and dietary supplements. Many dietary protein supplements contain allergens; dairy, soya, egg and nut allergies are becoming increasingly common and the prescribed restrictive diets can be a cause of dietary protein deficiency and a need for a protein supplementation with a product with lower allergenic potential.

### SUMMARY OF THE INVENTION

In a broad form, the invention is drawn to a protein food product, and more particularly a gummy composition, that provides an optimal or improved source of protein, while also optionally having a pleasant taste and texture and being visually appealing. In one form, the protein food product or gummy composition has a relatively low level of lipids and/or low allergenic potential. In particular, the invention provides an alternative to, for example, powdered protein supplements, allowing the consumer to fit their protein intake to their individual needs. The present invention is therefore broadly directed to a protein food product, such as gummy bites or pieces, comprising relatively high amounts of protein and relatively low amounts of lipids.

In a first aspect, the invention provides a protein food product comprising:

protein that optionally includes collagen protein, peptides and/or one or more amino acids or derivatives thereof;

one or more gelling agents; and

optionally one or more flavouring agents and/or one or more sweetening agents

wherein the total protein content of the protein food product is at least about 8% by weight and the total lipid content is less than about 60% by weight of the protein food product.

In one embodiment, the total lipid content is less than about 10% by weight of the protein food product. More particularly, the protein food product of the present aspect suitably comprises substantially no lipid.

In an alternative embodiment, the total lipid content is between about 10% to about 50% by weight of the protein food product. With respect to such embodiments, the protein food product suitably promotes, enhances and/or prolongs ketosis in a subject.

In certain embodiments, the total carbohydrate content of the protein food product is less than about 70%, less than about 50%, less than about 30% or less than about 10% by weight of the protein food product.

The protein food product may further comprise one or more humectants and/or one or more colouring agents.

In certain embodiments, the protein food product is in the form of a gummy composition.

In some embodiments, the invention provides a layered protein food product comprising a first layer comprising a “marshmallow” style bar according to the first aspect and a second layer comprising a “gummy” style bar according to the first aspect.

Suitably, the protein that includes collagen protein, peptides or derivatives thereof is or comprises a collagen hydrolysate, such as GELITA® BodyBalance™ bioactive collagen peptide. In one particular embodiment, the protein that includes collagen peptides or derivatives thereof is a combination of gelatine and a collagen hydrolysate.

Suitably, the gelling agent is or comprises a hydrocolloid, such as alginate, pectin, carrageenan, gelatine, gellan and agar. In particular embodiments, the gelling agent is, or comprises, gelatine, such as GELITA® 250 bloom bovine hide gelatine, porcine-derived gelatine and bone-derived gelatine.

Suitably, the protein food product further comprises one or more pH modifiers, including, but not limited to, organic acids such as malic acid, citric acid, lactic acid and/or ascorbic acid.

In one embodiment, the protein food product further comprises one or more humectants, such as glycerine.

In certain embodiments, the protein food product further comprises one or more colouring agents.

In some embodiments, the protein food product further comprises one or more vitamins and/or minerals.

Suitably, the protein food product has a specific gravity/density of about 1.2 to 1.6.

In a second aspect, the invention provides a method of producing a protein food product including the steps of:

(a) combining:

protein that optionally includes collagen protein, peptides and/or one or more amino acids or derivatives thereof;

one or more gelling agents; and

optionally one or more flavouring agents and/or one or more sweetening agents; and

(b) forming the protein food product, wherein the total protein content of the protein food product is at least about 8% by weight and the total lipid content is less than about 60% by weight of the protein food product.

The method may further include combining one or more humectants, one or more colouring agents, one or more pH modifiers and/or one or more vitamins and/or minerals.

Suitably, the method includes the further step of forming the protein food product in a mould.

Suitably, the protein food product is that of the first aspect.

In a third aspect, the invention resides in a protein food product produced according to the method of the second aspect.

In a fourth aspect, the invention provides a method for providing nutritional supplementation to a subject, including the step of administering to the subject an effective amount of the protein food product of the first or third aspects.

In a fifth aspect, the invention provides a method of promoting, enhancing and/or prolonging ketosis in a subject, including the step of administering to the subject an effective amount of a protein food product according to the first or third aspects.

Throughout this specification, unless otherwise indicated, “comprise”, “comprises” and “comprising” are used inclusively rather than exclusively, so that a stated integer or group of integers may include one or more other non-stated integers or groups of integers.

As used in this specification the indefinite articles “a” and “an” may refer to one entity or a plurality of entities and are not to be read or understood as being limited to a single entity.

As used in this specification, the term “about” refers to a variation or tolerance in a stated amount, concentration, ratio or proportion, preferably defined as being no more than 10%, 5%, 2% or 1% above or below a stated amount, concentration, ratio or proportion.

### DETAILED DESCRIPTION

The present invention relates to a protein food product, such as a food bar or a gummy composition like gummy bites or gummy pieces, comprising relatively high amounts of protein and relatively low amounts of lipids.

An aspect of the invention provides a protein food product comprising:

protein that optionally includes collagen protein, peptides and/or one or more amino acids or derivatives thereof;

one or more gelling agents; and

optionally one or more flavouring agents and/or one or more sweetening agents;

wherein the total protein content of the protein food product is at least about 8% by weight and the total lipid content is less than about 60% by weight of the protein food product.

The protein food product may further comprise one or more humectants and/or one or more colouring agents.

As generally used herein, the stated concentration, proportion or mass of any particular component or constituent of the protein food product may be made with reference to the concentration, proportion or mass of the particular component or constituent used to produce the protein food product, or may be the concentration, proportion or mass of the particular component or constituent in the final product.

It is also noted that the stated concentrations, proportions or masses of each component or constituent may be readily varied by a person of skill in the art. It will also be appreciated that concentrations, proportions or masses expressed in the range “x-y” include all values and sub-ranges within the stated range.

As used herein the term “protein” includes any amino acid polymer comprising D- or L-amino acids, natural or non-natural amino acids as are known in the art. Proteins, peptides and/or amino acids may be in the form of extracts, hydrolysates, purified, chemical synthetic, enriched or partially-purified forms.

In some embodiments, proteins may be obtained, derived, obtainable or derivable from natural sources such as plants and/or animals.

Animal sources include vertebrates such as mammals, reptiles, fish, and/or birds and invertebrates such as shellfish, crabs, lobsters and/or insects, although without limitation thereto. Non-limiting examples include whey protein concentrate, whey protein isolate, hydrolysed whey, casein, milk protein isolate, proteins from egg albumin, beef, lamb, pork, veal, venison, bison, goat, kangaroo, chicken, turkey, duck, emu, rabbit, fish, shellfish, crabs, lobster and/or crocodile, although without limitation thereto. In one embodiment, the protein food product is substantially free of milk or dairy-based or derived protein, such as whey and casein.

Plant sources include trees, vines, plant seeds, bark, roots, leaves, bulbs, tubers, nuts and/or fruit, although without limitation thereto. Plants may include grasses, cereals, legumes, seaweed, leafy vegetables, cruciform vegetables and fungi, although without limitation thereto. Non-limiting examples include soy protein, tofu, tempeh, pea protein, rice protein, bean proteins, corn protein, chickpea, faba bean, mungbean, chia protein, quinoa protein, spirulina protein, hemp seeds, lentils, nut proteins, heat germ protein, sorghum protein and proteins obtained, derived, obtainable or derivable from vegetables and/or fruit such as spinach, watercress, kale, broccoli, brussel sprouts, cauliflower, mushrooms, parsley, lettuce, zucchini, cucumber, capsicum, artichokes, cabbage, celery, eggplant, tomatoes, onion, beets, squash, pumpkin, potato, yams and/or sweet potato.

In particular embodiments, the protein comprises hydrolysed collagen protein, amino acids and/or peptides, or derivatives thereof.

As used herein, “peptides” are proteins having no more than about 70 contiguous amino acids. In the specific context of collagen, this is a structural protein typically present in connective tissue or other tissues located in animal bodies. Collagen may be fibrillar or non-fibrillar and may be classified into types, of which Types I-V are the most common. Collagen peptides may be produced by enzymatic (e.g., collagenase), acid or alkali partial hydrolysis of collagen protein.

Non-limiting sources of the collagen protein, amino acids and peptides, include gelatine and/or collagen hydrolysates.

Suitably, gelatine is present at a concentration of about 0.1-30% (e.g., 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30% and any range therein) by weight or particularly at about 5-10% by weight. Suitably, the gelatine is produced or derived from beef skin, such as by alkaline and/or acid treatment of collagen in the beef skin. In other embodiments, the gelatine is or comprises porcine-derived and/or bone-derived gelatine. An exemplary gelatine bloom value is about 125-300 (e.g., 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300 or any range therein) or more particularly about 225-280, and even more particularly, about 250.

In one particular embodiment, the gelatine is or comprises GELITA® 250 bloom bovine hide gelatine.

According to particular embodiments of the invention, the protein fraction of the protein food product comprises a collagen hydrolysate with or without gelatine.

In contrast to gelatine, which is also a hydrolysis product of collagen, the term “collagen hydrolysate” refers to a collagen-derived product, such as native animal collagen, hydrolysed to an extent such that it no longer gels under the conditions of the standard Bloom test (i.e., has a Bloom strength of zero g). Unlike gelatine which is hot water soluble and has an average molecular weight of 180 kDa, collagen hydrolysates tend to be cold water soluble and range in molecular weight from 2 kDa to 12 kDa.

In some embodiments, the collagen hydrolysate is a food ingredient that is derived by enzymatic hydrolysis of native animal collagen. It will be appreciated that a collagen hydrolysate can, in particular embodiments, be produced by the enzymatic hydrolysis of gelatine. In particular embodiments, however, the collagen hydrolysate is free or substantially free of a gelatine hydrolysate (e.g., has no more than about 0.5%, 0.2%, 0.1% or 0.05% a gelatine hydrolysate by weight thereof) or is substantially not derived or produced from the hydrolysis of gelatine.

Suitably, collagen hydrolysate is present at a concentration of about 1-60% (e.g. 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60% and any range therein) by weight or particularly about 35-50% by weight.

In particular embodiments, the collagen hydrolysate has an average molecular weight of about 500 to about 10000 Da (e.g., 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5500, 6000, 6500, 7000, 7500, 8000, 8500, 9000, 9500, 10000 Da and any range therein), and more particularly about 2,000 to 4,000 Da. In the context of the present description, all information relates to the weight-average molecular weight of the collagen hydrolysate. This can be determined in particular by means of gel permeation chromatography using calibrated standard peptides. Suitably, the collagen hydrolysate is produced by enzymatic hydrolysis of a collagen-containing starting material. Endopeptidases or exopeptidases of microbial or plant origin as are known in the art may be used for this hydrolysis. By suitable selection of the peptidases and the hydrolysis conditions, collagen hydrolysates can be produced in the molecular weight range required in each case.

The collagen-containing starting material is generally derived from, for example the skin or bones of vertebrates, such as mammals, fish or birds, and in particular from the skin of cattle or pigs (cattle split or pork split).

An exemplary collagen hydrolysate is GELITA® BodyBalance™ bioactive collagen peptides. This collagen hydrolysate is derived from a complex multi-step procedure by the degradation of type I collagen and can be defined by numerous specific collagen peptides with an average molecular weight of 3.5 kDa. Bioactive Collagen Peptides, for example GELITA® BodyBalance™ can also be defined by a specific matrix-assisted laser desorption ionization mass spectrometry mass peaks fingerprint and a specific amino acid profile, as per the below table.

| Amino Acid | Weight (%) | Mol (%) |
|---|---|---|
| Hydroxyproline | 11.3 | 9.6 |
| Aspartic acid | 5.8 | 4.8 |
| Serine | 3.2 | 3.4 |
| Glutamic acid | 10.1 | 7.5 |
| Glycine | 22.1 | 32.3 |
| Histidine | 1.2 | 0.8 |
| Arginine | 7.8 | 5.0 |
| Threonine | 1.8 | 1.7 |
| Alanine | 8.5 | 10.5 |
| Proline | 12.3 | 11.8 |
| Tyrosine | 0.9 | 0.5 |
| Hydroxylysine | 1.7 | 1.2 |
| Valine | 2.4 | 2.3 |
| Methionine | 0.9 | 0.9 |
| Lysine | 3.8 | 2.9 |
| Isoleucine | 1.3 | 1.1 |
| Leucine | 2.7 | 2.3 |
| Phenylalanine | 2.1 | 1.4 |

In another embodiment, the collagen hydrolysate is not or is not comprised of GELITA® Verisol™ bioactive collagen peptides. GELITA® Verisol™ bioactive collagen peptides can be defined by a matrix-assisted laser desorption ionization mass spectrometry mass peaks fingerprint with specific collagen peptides of an average molecular weight of 2.0 kD that are optimized for skin health.

In particular embodiments, the protein food product further comprises a further amino acid. To this end, the further amino acid can be any known in the art, inclusive of essential and non-essential amino acids, as well as derivatives or variants thereof, such as amino acid salts. Nonlimiting examples include leucine, isoleucine, valine, lysine, glutamine, threonine, phenylalanine, methionine, tryptophan, histidine, taurine, arginine, serine, proline, glycine, alanine, ornithine, citrulline, urocanic acid, asparagine and tyrosine. In particular embodiments, the further amino acid is selected from the group of leucine, isoleucine, valine, lysine, glutamine, threonine, phenylalanine, methionine, tryptophan, histidine, taurine, and any combination thereof.

With respect to the recited protein content of the protein food product, it will be appreciated that the further amino acid content will be taken into consideration together with the recited protein when calculating the protein content by weight of the protein food product.

The protein food product may include one or more further amino acids in addition to the protein, such as those hereinbefore described, in a wt % concentration of about 0.1% to about 50% or any range therein such as, but not limited to, about 1% to about 35% or about 2% to about 20%. In particular embodiments the further amino acid is present at a wt % concentration of about 0.1, 0.2, 0.3, 0.4, 0.5, 0.6, 0.7, 0.8, 0.9, 1, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, 9.75, 10, 10.25, 10.5, 10.75, 11, 11.25, 11.5, 11.75, 12, 12.25, 12.5, 12.75, 13, 13.25, 13.5, 13.75, 14, 14.25, 14.5, 14.75, 15, 15.25, 15.5, 15.75, 16, 16.25, 16.5, 16.75, 17, 17.25, 17.5, 17.75, 18, 18.25, 18.5, 18.75, 19, 19.25, 19.5, 19.75, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 and any range therein. In particularly preferred embodiments, the protein food product comprises from about 1 wt % to about 50 wt % of the further amino acid.

The gelling agent(s) may be or comprise any substance capable of creating a substantially homogeneous glutinous, thickened, semi-solid, jelly-like or gummy-like state. Suitably, the gelling agent is a hydrocolloid. Non-limiting examples of gelling agents include starch, modified starch, agar, xanthan, galactomannans like guar gum and locust bean gum (LBG), gum Arabic or acacia gum, gellan gum, gum karaya, gum tragacanth, alginate, pectin, carrageenan and carboxymethyl cellulose (CMC). The thickening effect produced by gelling agents such as hydrocolloids depends on the type of hydrocolloid used, its concentration, the food system in which it is used and also the pH of the food system and temperature.

Suitably, the gelling agent is, or comprises, gelatine. In one particular embodiment, the gelatine is or comprises GELITA® 250 bloom bovine hide gelatine.

Typically, the gelling agent, such as gelatine, or combination of gelling agents is present at a concentration of about 0.1-30% (e.g., 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30% and any range therein) by weight, or more particularly about 0.3-10% by weight. It will be appreciated that the level of gelling agent suitably results in a protein food product or a gummy composition that is compressible.

The flavouring agents may be any natural or non-natural substance which adds or enhances flavour. The flavouring agents may also comprise natural or non-natural stabilizers, anti-caking and/or flow agents. Flavouring agents are typically comprised of a flavoured substance(s) and complexes manufactured or extracted from nature in liquid or powdered form to impart a particular flavour into a product.

Excipients can be added to preserve, stabilize and maintain form and colour of the protein food product. Typical excipients may include flow agents, anticaking agents, antioxidants, including but not exclusively, MCT oil, ethanol, maltodextrin, gum acacia, tapioca starch, propylene glycol and triacetin.

The sweetening agents may be any natural, synthetic or artificial sweetening agent inclusive of sugar alcohols or polyols (e.g., erythritol, mannitol, xylitol, sorbitol, maltitol, glycerol), aspartame, stevia, honey, corn syrup, neotame, agave nectar, rice malt, saccharin and sucralose, sucrose, glucose, high fructose corn syrup, fructose (such as from fruit juice or fruit concentrates), isomaltulose (Palatinose™), dextrose, polydextrose, ribose, maltose, thaumatin, glycine, monk fruit, magrosides, although without limitation thereto. Suitably, the sweetening agent or combination of sweetening agents are present at a concentration of about 0.1-70% (e.g., 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70% and any range therein) by weight, more particularly about 15-30% by weight or even more particularly about 20-25% by weight of the protein food product.

In certain embodiments, the sweetening agent is not, or does not comprise, a sugar such as sucrose or fructose. In alternative embodiments, the sweetening agent is or comprises a sugar, such as sucrose and/or glucose syrup from various sources.

In certain embodiments, the sweetening agent is or comprises a low GI carbohydrate, such as isomaltulose and/or polydextrose. By low “GI” or low “glycaemic index” is meant a GI of less than about 60%, more particularly less than about 50%, advantageously less than about 40% or less than 30%, 20% or 10%.

In other embodiments, the sweetening agent comprises erythritol and/or stevia.

It will be appreciated that the quantity or concentration of the flavouring agent and/or the sweetening agent should be high enough to sufficiently mask any undesirable flavours, such as bitterness, associated with the source of protein.

The protein food product may further comprise one or more humectants. By “humectant” is meant a molecule, compound or substance that facilitates, promotes or enhances retention of moisture in the protein food product. Typical humectants comprise one or more hydrophilic groups that can form hydrogen bonds with water. Non-limiting examples include polyols such as polydextrose and sugar alcohols such as glycerol/glycerine, sorbitol, xylitol, mannitol, although without limitation thereto. To this end, it will be appreciated that certain humectants may also function as sweetening agents.

Suitably, the humectant or combination of humectants are present at a concentration of about 0.1-70% (e.g., 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70% and any range therein) by weight, more particularly about 15-50% by weight or more particularly about 25-45% by weight of the protein food product.

Additional ingredients that may be present in the protein food product include “gummy” bits or other flavoured particles, fruit pieces or powders, fruit juices or liquids, coconut, coconut milk powder, nuts, seeds, cacao nibs, coffee nibs, chocolate nibs or drops, and/or a gel or sauce swirl such as chocolate or caramel, although without limitation thereto.

In some embodiments, the protein food product may be coated, such as with a chocolate, a sour layer (e.g., sour sanding, sour sugar) or other coating. In embodiments where the protein food bar comprises a chocolate coating, the coating process would be as typically used in the art.

Suitably, the gummy composition further comprises one or more pH modifiers.

Suitably, the sweetening agent is present at a concentration of about 5-15% by weight, more particularly about 7-12% by weight or even more particularly about 9-11% by weight. Preferably, the sweetening agent comprises a sugar alcohol such as erythritol and stevia. According to this embodiment, a preferred ratio of a sugar alcohol such as erythritol to stevia is about 400:1-500:1 by weight.

The pH modifiers may be any agent, substance or molecule that facilitates obtaining and/or maintaining an optimal pH for the food product. The pH modifier may be a buffering agent, acid or base that facilitates achieving an acidic pH, an alkaline pH or neutral pH (i.e., about pH 7). Typically, the pH modifier is an acid, such as an organic acid. Organic acids may be any food grade acid, such as a carboxylic acid, that is suitable for human consumption and includes salts of said organic acids. Non-limiting examples include tartaric acid, citric acid, lactic acid, benzoic acid, acetic acid, malic acid, ascorbic acid, succinic acid, fumaric acid, oxalic acid and their salts (e.g., tartrates, citrates, lactates etc). In certain embodiments, the organic acids are citric acid, malic acid and/or ascorbic acid. In view of this, it will be appreciated that the one or more pH modifiers may be included in the protein food product as part of a fruit juice, or concentrate or extract thereof, such as those hereinbefore described.

Suitably, the pH modifiers are present at a concentration of about 0.1-5% (e.g., 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5% and any range therein) by weight in total, or more particularly about 2-3% by weight in total. In an embodiment, citric acid is present at about up to 3.0% by weight of the protein food product.

In particular embodiments, the protein food product has a specific gravity or density of about 1.1-1.7 (e.g., 1.10, 1.15, 1.20, 1.25, 1.30, 1.35, 1.40, 1.45, 1.50, 1.55, 1.60, 1.65, 1.70 and any range therein) or in certain embodiments about 1.3-1.45. In alternative embodiments, such as those in which the protein food product has been aerated, the protein food product has a specific gravity or density of about 0.4-0.8 (e.g., 0.40, 0.45, 0.50, 0.55, 0.60, 0.65, 0.70, 0.75, 0.80 or any range therein) or suitably about 0.5-0.7.

Typically, the protein food product is non-aerated or de-aerated with no visible bubbles in the food mass. Additionally, the appearance of the protein food product is suitably of a transparent or semi-transparent nature. In this regard, it has been determined by the present inventors that the use of a collagen-based protein, such as a collagen hydrolysate, advantageously facilitates the production of at least a semi-transparent (i.e., reduced turbidity and improved clarity), and hence more aesthetically pleasing, protein food product compared with, for example, the use of whey protein.

In other embodiments, the protein food product is aerated so as to form a “marshmallow” style gummy composition. For such embodiments, the appearance of the protein food product is typically of an opaque nature. The marshmallow-style bite or piece, typically comprises an aerated mass with uniform air bubbles throughout. Suitably, the appearance of such a protein food product is an off white or pastel/lightly coloured (depending on flavour of the bar), and texture is similar to a short-textured marshmallow, highly elastic and has a clean bite with no “stickiness”. The marshmallow bar may have relatively low water content and water activity. By way of example, water content may be below about 20% and a_{w} around 0.7-0.9, although without limitation thereto

A non-limiting example of a “marshmallow” style, aerated protein bar according to this embodiment is described in Example 1.

In a second particular embodiment the protein food product is referred to herein as a “gummy” style protein bar. Suitably, the protein food product of this second embodiment is not aerated and has a more dense texture compared to the marshmallow bar. Suitably, the protein food product of this second embodiment has a specific gravity or density substantially greater than that of the first particular embodiment. The “gummy” bar would have a density of about 1.2-1.6 or preferably about 1.3-1.45. Typically, the gummy bar is non-aerated or deaerated with no visible bubbles in the food mass. Appearance is of a transparent gel with deep colouring based on flavours, texture very short and elastic similar to a gelatine confectionery with a clean bite. Preferably, the gummy bar has a higher water content and/or density than the marshmallow bar.

A non-limiting example is described in Example 2.

In a third particular embodiment, the protein food product is a layered protein food product that comprises at least two layers, a first of said two layers comprising the protein food product of the first particular embodiment and a second of said two layers comprising the protein food product of the second particular embodiment, wherein the total protein content of the food product is at about 20-60% by weight, the total carbohydrate content is about 2-10% by weight and the total lipid content is about 0-10% by weight.

A preferred mass ratio of the protein food product of the first particular embodiment and the protein food product of the second particular embodiment is about 1:1-3:1, preferably about 2:1.

In a fourth particular embodiment the protein food product is referred to herein as a ketogenic protein bar. As will be appreciated by the skilled artisan, a ketogenic food product, which may form part of a ketogenic diet, generally derives a significant proportion of its energy from fat or lipid (e.g., about 40, 45, 50, 55, 60, 65, 70, 75% and any range therein) and only a small proportion of energy from carbohydrates (e.g., about 0, 1, 2, 3, 4, 5, 6, 7, 8, 9, 10% and any range therein). Such food products or diets are typically designed to force the body to burn fats rather than carbohydrates for energy. Accordingly, following consumption, digestion and metabolism, a ketogenic food product or diet generally provides ketones as a major energy source. These ketonic compounds include, for example, aceto acetate, D-3 hydroxy butyrate and acetone. A ketogenic food product or diet may induce a metabolic state known as ketosis, characterised by elevated levels of circulating ketone bodies (e.g., serum ketone body levels over 0.5 millimolar), together with low and stable levels of insulin and blood glucose. In particular embodiments, the protein food product promotes, enhances and/or prolongs ketosis in a subject.

Accordingly, for the protein food product of this fourth embodiment, the total lipid content is suitably between about 10% to about 60% by weight of the protein food product.

Additionally, the total protein content of the food product of this fourth embodiment is at about 10-60% by weight and the total carbohydrate content is about 0-10% by weight.

A non-limiting example is described in Example 3.

In a fifth particular embodiment the protein food product is referred to herein as a gummy composition. The term “gummy” as used herein is a term of the art and any gummy composition which provides the necessary texture can be used. Gummy products are generally chewable and often classified as candies or lollies. The texture of a gummy is in part a result of the presence of a gelling or gelating agent, such as gelatine, although vegetarian-friendly substitutes as known in the art can be used without impacting on the texture. Particular gummy compositions of the invention include one or more gelling agents selected from gelatine and/or pectin.

The gummy composition of the invention will typically be provided in the form of individual gummy pieces. It is envisaged that these pieces can be moulded into a shape to increase their consumer appeal, e.g., animal shapes, fruit shapes, soda bottles, heart shapes, geometric shapes and company logos, using conventional methods known in the art.

According to one or more embodiments herein, the gummy composition can be used in various applications, such as bodybuilding/fitness supplements, vitamin/mineral formulas, smoothies, fruit juices, and powdered drinks, breakfast cereals and cereal bars, ice creams, yogurts and dairy products.

The gummy composition suitably has a water content of about 5-40% (5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40% and any range therein) by weight in total, or more particularly about 10-25% by weight in total.

Another particular aspect of the invention provides a method of producing a protein food product including the steps of:

(a) combining:

protein that optionally includes collagen protein, peptides and/or one or more amino acids or derivatives thereof;

one or more gelling agents; and

optionally one or more flavouring agents and/or one or more sweetening agents; and

(b) forming the protein food product, wherein the total protein content of the protein food product is at least about 8% by weight and the total lipid content is less than about 60% by weight of the protein food product.

In some embodiments, the method further includes combining one or more humectants, one or more colouring agents, one or more pH modifiers and/or one or more vitamins and/or minerals.

In one embodiment, the above method further includes the step of moulding the protein food product.

Suitably, the protein food product is according to that described herein.

An exemplary method of the present aspect includes the steps of:
heating the gelling agent(s) in water to produce a mixture;
heating the sweetener and humectant in the above mixture once the gelling agent is dissolved and/or desired solids level is achieved;
dissolving and heating the protein that includes collagen peptides or derivatives thereof in water;
adding the protein that includes collagen peptides or derivatives thereof to the first mixture;
adding the one or more pH modifiers, one or more colouring agents, one or more flavouring agents and the one or more sweetening agents to the mixture;
aerating or deaerating the mixture; and
placing the mixture in a mould.

In one embodiment, the method is for producing the protein food of the first embodiment, whereby the mixture is produced by combining the gelling agent, as hereinbefore described, with water and heating, such as to about 100° C. for about 1 minute. The collagen peptides are dissolved separately in water and heated to 70° C. Once the gelling agent is heated and ‘activated’ the humectant and erythritol are then added to this solution and cooked until a suitable solids content is reached. Once appropriate solids are reached the gelatine included into the cook and is stirred until the gelatine has dissolved. The first mixture is then added to the collagen/water mixture and incorporated well before adding the flavours, colours, acid and sweetener (stevia). Suitably, the one or more flavouring agents, the one or more sweetening agents and one or more organic acids, such as hereinbefore described, are added to the mixture. The mixture is then aerated to a specific gravity/density between 0.5 and 0.7. The mixture may be held at about 70° C. in its aerated form until ready to deposit.

Subsequently, the mixture is placed into a mould, such as a silicone or plastic mould. Preferably, the mould has been sprayed with a neutral flavoured oil to ensure the product can easily be removed once set. The product is allowed to cool and partially set for between 1-2 hours before demoulding and packing.

In the second embodiment, the method is for producing the protein food of the second embodiment, whereby the mixture is produced by combining the gelling agent, as hereinbefore described, with water and heating, such as to about 100° C. for about 1 minute. The collagen peptides are dissolved separately in water and heated to 70° C. Once the gelling agent is heated and ‘activated’ the humectant and erythritol are then added to this solution and cooked until a suitable solids content is reached. Once appropriate solids are reached the gelatine included into the cook and is stirred until the gelatine has dissolved. The first mixture is then added to the collagen/water mixture and incorporated well before adding the flavours, colours, acid and sweetener (stevia). Suitably, the one or more flavouring agents, the one or more sweetening agents and one or more organic acids, such as hereinbefore described, are added to the mixture. The mixture is then deaerated to remove all air bubbles either in an ultrasonic chamber or pressurised chamber. The mixture may be held at about 70° C. in this form until ready to deposit.

Subsequently, the mixture is placed into a mould, such as a silicone or plastic mould. Preferably, the mould has been sprayed with a neutral flavoured oil to ensure the product can easily be removed once set. The product is allowed to cool and partially set for between 1-2 hours before demoulding and packing.

In another embodiment, the method is for producing the protein food of the third embodiment. Accordingly, the method includes producing first and second layers, the first layer produced by the method of the first embodiment and the second layer produced by the method of the second embodiment.

Subsequently, the mixture is placed into a mould, such as a silicone or plastic mould, as a second layer combined with a first layer comprising the protein food of the first embodiment.

A preferred mass ratio of the protein food product of the first particular embodiment and the protein food product of the second particular embodiment is about 1:1-3:1, preferably about 2:1. Typically, this is 15:30 g.

Suitably, according to the aforementioned aspects and embodiments, the total protein content of the food product is at least about 8% by weight and up to about 80% (e.g., 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80% and any range therein) by weight, more particularly about 25-75% by weight, even more particularly about 30-70%, by weight, or advantageously about 40-55% or 41, 42, 43, 44, 45, 46, 47, 48, 49, 50, 51, 52, 53 or 54% by weight, or any range between these stated values.

Suitably, the total carbohydrate content is between about 0.5-70% by weight, such as 0, 0.5, 1, 1.5, 2, 2.5, 3, 4, 5, 6, 7, 8, 9, 10, 15, 20, 30, 35, 40, 45, 50, 55, 60, 65, 70% by weight, or any range between these stated values, although without limitation thereto. In one particular embodiment, the total carbohydrate content is less than about 60% by weight.

Suitably, the total lipid content is between about 0-60% by weight, such as 0, 1, 2, 3, 4, 5, 6, 7, 8, 9, 10, 15, 20, 25, 30, 35, 40, 45, 50, 55, 60% by weight, or any range between these stated values, although without limitation thereto. In particular embodiments, the total lipid content is between about 0-10% by weight, such as 0, 1, 2, 3, 4, 5, 6, 7, 8, 9, 10% by weight, or any range between these stated values, although without limitation thereto. In certain embodiments, the protein food product comprises substantially no lipid.

In alternative embodiments, the total lipid content is between about 10% to about 50% by weight, and more preferably, about 30% to about 50% by weight of the protein food product. With respect to such embodiments, the protein food product suitably promotes, enhances and/or prolongs ketosis in a subject.

In some embodiments, the protein food product comprises substantially no fibre. In other embodiments, the protein bar includes fibre, such as between about 0.5-20% (e.g., 0.5, 1, 2, 3, 4, 5, 6, 7, 8, 9, 10, 11, 12, 13, 14, 15, 16, 17, 18, 19, 20% and any range therein).

By “fibre” is meant substantially indigestible complex carbohydrates inclusive of soluble and insoluble dietary fiber, such as including arabinoxylans, polydextrose, cellulose, starch, lignins, pectins, alginates, dextrins, chitins, poly- and oligo-saccharides typically, although not exclusively, derived from plants.

Other optional components of the food product disclosed herein include vitamins and/or minerals, and in particular vitamins from plant sources. Non-limiting examples include vitamin A, B complex vitamins, (e.g., vitamins B₁, B₃, B₆, B₁₂, folate/B₉), vitamin C, vitamin D, vitamin E and/or vitamin K, although without limitation thereto.

Minerals may include elements such as iron, zinc, calcium, selenium, potassium, manganese and/or magnesium, inclusive of salts and complexes containing these elements, although without limitation thereto.

Yet further optional components of the food product disclosed herein include fruit extracts such as strawberry, raspberry, coconut, blueberry, apple, banana, pineapple, citrus and/or grape extracts, although without limitation thereto.

In a related aspect, the invention resides in a protein food product produced according to the method of the aforementioned aspect.

In another aspect, the invention provides a method of promoting, enhancing and/or prolonging ketosis in a subject, including the step of administering to the subject an effective amount of a protein food product described herein.

In this regard, the protein food product preferably comprises a total lipid content of between about 10% to about 50% by weight, and more preferably, about 30% to about 50% by weight of the protein food product.

Accordingly, the present method can further include the further step of providing a protein food product comprising:
protein that optionally includes collagen protein, peptides and/or one or more amino acids or derivatives thereof;
one or more gelling agents; and
optionally one or more flavouring agents and/or one or more sweetening agents;

wherein the total protein content of the protein food product is at least about 10% by weight and the total lipid content is less than about 50% by weight of the protein food product.

In yet another aspect, the invention provides a method for providing nutritional supplementation to a subject, including the step of administering to the subject an effective amount of the protein food product described herein.

In particular embodiments, the present method is designed to supplement the nutritional or protein intake of subjects engaged in bodybuilding and protein supplementation, meal replacement, exercise recovery and/or mass gaining.

In other embodiments, the present method is designed to supplement the nutritional or protein intake of subjects suffering from age-related and/or disease-related muscle loss, such as sarcopenia and muscle loss associated with rheumatoid arthritis, diabetes, hormonal imbalances, peripheral arterial disease, COPD, congestive heart failure, advanced kidney disease, cirrhosis, cancer, and HIV.

By “effective amount” it is meant an amount of the protein food product that promotes, enhances and/or prolongs ketosis and/or is sufficient to meet, at least in part, the specific nutritional requirements of the subject. Such amounts or concentrations can be determined routinely by those of ordinary skill in the art, for example, based upon blood-based assays, such as described herein or through other art-recognized means.

In some embodiments, the protein food product may be utilized or administered once a day, twice a day, three times a day, four times a day, five times a day, six times a day, seven times a day, eight times a day, nine times a day, ten times a day, etc., or more, as needed.

So that particular embodiments of the invention may be fully understood and put into practical effect, reference is made to the following non-limiting examples.

### EXAMPLES

### Example 1

A protein “marshmallow” style bar is to have a minimum of 15 g daily serving of Bioactive Collagen Peptides (for example GELITA BODYBALANCE™) with up to 40 g of protein in total, further nutritional requirements are to include no more than 5 grams of carbohydrates and 2 grams or less of sugar.

### Product 1—Marshmallow Bar

| | | |
|---|---|---|
| A: | DAVIS ® J3 Agar | 0.47% |
| | Water | 9.38% |
| B: | Bioactive Collagen Peptides | 46.97% |
| | GELITA ® BODYBALANCE ™ | |
| | Water | 9.38% |
| C: | Erythritol | 9.28% |
| | Gelatine | 6.84% |
| D: | Polydextrose | 10.03% |
| | Water | 3.75% |
| E: | Flavours | 0.70% |
| | Colours | 0.09% |
| | Stevia | 0.05% |
| | Malic Acid | 0.95% |
| | Ascorbic Acid | 1.90% |
| | Tryptophan | 0.02% |
| | Cultured Dextrose | 1.88% |

### Process

1. Cook part A to boiling and hold for 1 minute, once partially thickened add part C and mix well and cook until. Mix part B together and heat and hold at 70° C. while other ingredients cook. Add part D to part A and C mixture and continue to cook. Once syrup reaches a specific solids content, add to mixture B and mix well. Add in components of part E and incorporate well, once incorporated aerate the mixture to a specific gravity/density of 0.5-0.7. Keep the mixture at around 70° C. in a hopper or holding tank until ready to deposit.
2. Deposit the syrup into oiled silicone or plastic moulds. Dry the bars at room temperature for 1-2 hrs, remove bars from moulds and pack.

### Nutritional Panel

| | Per 100 grams | Per 60 g |
|---|---|---|
| Energy (Calories) | 227.11 | 136.27 |
| Energy (KJ) | 950.60 | 570.36 |
| Protein (g) | 53.91 | 32.34 |
| Fats Total (g) | 0.00 | 0.00 |
| Fats Saturated (g) | 0.00 | 0.00 |
| Carbs (g) | 2.03 | 1.22 |
| Dietary Fibre (g) | 9.55 | 5.73 |
| Sodium (mg) | 31.99 | 19.19 |

### Example 2

A protein “gummy/jelly” style bar is to have a minimum of 15 g daily serving of Bioactive Collagen Peptides (for example GELITA BODYBALANCE™) with up to about 40 g of protein in total, further nutritional requirements are to include no more than 5 grams of carbohydrates and 2 grams or less of sugar.

### Product 2—Gummy Style Bar

| | | |
|---|---|---|
| A: | DAVIS ® J3 Agar | 0.42% |
| | Water | 9.78% |
| B: | GELITA ® BODYBALANCE ™ | 37.17% |
| | Water | 18.59% |
| C: | Erythritol | 7.34% |
| | Gelatine | 6.36% |
| D: | Polydextrose | 12.23% |
| | Water | 4.89% |
| E: | Flavours | 0.73% |
| | Colours | 0.19% |
| | Stevia | 0.04% |
| | Malic Acid | 0.88% |
| | Ascorbic Acid | 0.39% |
| | Tryptophan | 0.01% |
| | Cultured Dextrose | 0.98% |

### Process

1. Cook part A to boiling and hold for 1 minute, once partially thickened add part C and mix well and cook until. Mix part B together and heat and hold at 70 degrees while other ingredients cook. Add part D to part A and C mixture and continue to cook. Once syrup reaches a specific solids content, add to mixture B and mix well. Add in components of part E and incorporate well, once incorporated deaerate the mixture until solution is clear. Keep the mixture at around 70° C. in a hopper or holding tank until ready to deposit.
2. Deposit the syrup into oiled silicone or plastic moulds. Dry the bars at room temperature for 1 -2hrs, remove bars from moulds and pack.

### Nutritional Panel

| | Per 100 grams | Per 60 g |
|---|---|---|
| Energy (Calories) | 227.17 | 136.30 |
| Energy (KJ) | 951.03 | 570.62 |
| Protein (g) | 53.40 | 32.04 |
| Fats Total (g) | 0.00 | 0.00 |
| Fats Saturated (g) | 0.00 | 0.00 |
| Carbs (g) | 0.80 | 0.48 |
| Dietary Fibre (g) | 13.81 | 8.28 |
| Sodium (mg) | 27.96 | 16.77 |

### Example 3

A ketogenic protein bar is embodied below, which provides a source of calories from the below listed macronutrients for a ketogenic diet:
Calories from carbohydrates: 3%
Calories from Protein: 9%
Calories from Fat: 68%

The below link (which is incorporated by reference herein) explains how a ketogenic diet provides support for these parameters: https://www.nchi.nlm.nih.gov/books/NBK499830/.

### Recipe

Chocolate
BOM

| | | | | | | R154 | | | | | | | | |
|---|---|---|---|---|---|---|---|---|---|---|---|---|---|---|
| | | | | | | Trypto- | | | | | | | | |
| | | | | | R152 | phan | | R135 | | | | | | |
| R085 | R144 | | | | Choco- | (NO | | Agar | | | | | | |
| Gelita | Polydex- | | | R150 | late | NUTRI- | | (esti- | | Coco- | | | | |
| Hydro- | trose | | | Cul- | Liq- | TIONAL | | mated, | | nut | | | | |
| lysed | (low | R137 | R136 | tured | uid | DATA | R107 | not | | Milk | Coco- | | | |
| Colla- | reducing | Eryth- | Gela- | Dex- | Fla- | AVAIL- | Stevia | supplier | | Pow- | nut | Coconut | N/A | |
| gen | sugar) | ritol | tine | trose | vour | ABLE) | 97% | info) | Cacao | der | Oil | Flakes | Water | |
| 28.69 | 14.34 | 7.10 | 5.38 | 1.79 | 0.47 | 0.01 | 0.05 | 0.36 | 3.59 | 10.76 | 3.59 | 7.17 | 16.71 | 100.01 |
| 28.69% | 14.34% | 7.10% | 5.38% | 1.79% | 0.47% | 0.01% | 0.05% | 0.36% | 3.59% | 10.76% | 21.48% | 7.17% | 16.71% | 117.89% |

### Nutritional Panel

| | Per 100 grams | Per 70 g |
|---|---|---|
| Energy (Calories) | 670.29 | 469.21 |
| Energy (KJ) | 1675.49 | 1172.84 |
| Protein (g) | 34.37 | 24.06 |
| Fats Total (g) | 35.92 | 25.14 |
| Fats Saturated (g) | 34.96 | 24.47 |
| Carbs (g) | 3.61 | 2.53 |
| Sugar (g) | 0.75 | 0.52 |
| Dietary Fibre (g) | 14.34 | 10.04 |
| Sodium (mg) | 30.71 | 21.50 |

### Example 4

A glycerine dispersion high protein gummy product, such as gummy bites or pieces, is embodied below.

| Ingredient | | Concentration |
|---|---|---|
| Part A | Sugar | 11.0% |
| | 42DE Glucose Syrup | 13.0% |
| | Water | 2.0% |
| Part B | Collagen | 20.0% |
| | BODYBALANCE | |
| | Glycerine | 30.0% |
| Part C | Water | 16.0% |
| | Gelatine | 8.0% |
| Part D | Citric Acid | 3.0% (over total) |
| | Colours and Flavours | 0.43% (over total) |

Method:

Disperse collagen in glycerine and allow to heat and dissolve at 70° C. (Part B)

Dissolve gelatine in water at 60° C. (Part C)

Cook Sugar, Glucose syrup and water (Part A) to 118° C. (approximately 86% solids)

Allow Sugar syrup to cool to 100° C. and then incorporate gelatine and collagen solutions into the syrup.

Once syrup is below 80° C. add colours, flavours and lastly acid. (Part D)

Deposit into moulds and allow to set at the appropriate time and temperature.

Demould product and coat in confectioners glaze/oil to prevent sticking.

Total Depositing Solids 76-82%

### Nutritional Panel

| | Per 100 grams |
|---|---|
| Energy (Calories) | 302.56 |
| Energy (KJ) | 1265.90 |
| Protein (g) | 26.55 |
| Fats Total (g) | 0.00 |
| Fats Saturated (g) | 0.00 |
| Carbs (g) | 50.42 |
| Sugar (g) | 14.43 |
| Dietary Fibre (g) | 0.00 |
| Sodium (mg) | 47.10 |

### Example 5

A regular high sugar confectionery base is used in the example below.

| Ingredient | | Concentration |
|---|---|---|
| Part A | Sugar | 20.69% |
| | 42DE Glucose Syrup | 32.30% |
| | Water | 4.49% |
| Part B | Collagen | 18.73% |
| | BODYBALANCE | |
| | Water | 11.52% |
| Part C | Water | 6.55% |
| | Gelatine | 5.71% |
| Part D | Citric Acid | 3.0% (over total) |
| | Colours and Flavours | 0.43% (over total) |

Method:

Disperse collagen in water and allow to heat and dissolve at 70° C. (Part B)

Dissolve gelatine in water at 60° C. (Part C)

Cook Sugar, Glucose syrup and water (Part A) to 118° C. (approximately 86% solids)

Allow Sugar syrup to cool to 100° C. and then incorporate gelatine and collagen solutions into the syrup.

Once syrup is below 80° C. add colours, flavours and lastly acid. (Part D)

Deposit into moulds and allow to set at ambient temperature for a minimum of 4 hours.

Demould product and coat in confectioners glaze/oil to prevent sticking.

Total Depositing Solids 76-82%

### Nutritional Panel

| | Per 100 grams |
|---|---|
| Energy (Calories) | 276.39 |
| Energy (KJ) | 1156.39 |
| Protein (g) | 24.22 |
| Fats Total (g) | 0.00 |
| Fats Saturated (g) | 0.00 |
| Carbs (g) | 46.49 |
| Sugar (g) | 30.12 |
| Dietary Fibre (g) | 0.00 |
| Sodium (mg) | 50.32 |

### Example 6

A low GI confectionery base is used in the example below.

| Ingredient | | Concentration |
|---|---|---|
| Part A | Palatinose | 26.53% |
| | 42DE Glucose Syrup | 25.97% |
| | Water | 4.45% |
| Part B | Collagen | 18.55% |
| | BODYBALANCE | |
| | Water | 11.41% |
| Part C | Gelatine | 5.66% |
| | Water | 7.42% |
| Part D | Citric Acid | 3.0% (over total) |
| | Colours and Flavours | 0.43% (over total) |

Method:

Disperse collagen in water and allow to heat and dissolve at 70° C. (Part B)

Dissolve gelatine in water at 60° C. (Part C)

Palatinose, Glucose syrup and water (Part A) heated to 118° C. (approximately 86% solids)

Allow Sugar syrup to cool to 100° C. and then incorporate gelatine and collagen solutions into the syrup.

Once syrup is below 80° C. add colours, flavours and lastly acid. (Part D)

Deposit into moulds and allow to set at ambient temperature for a minimum of 4 hours.

Demould product and coat in confectioners glaze/oil to prevent sticking.

Total Depositing Solids 76-82%

### Nutrition Panel

| | Per 100 grams |
|---|---|
| Energy (Calories) | 281.50 |
| Energy (KJ) | 1177.77 |
| Protein (g) | 23.93 |
| Fats Total (g) | 0.00 |
| Fats Saturated (g) | 0.00 |
| Carbs (g) | 47.39 |
| Sugar (g) | 7.37 |
| Dietary Fibre (g) | 0.00 |
| Sodium (mg) | 48.08 |

### Example 7

A low sugar confectionery base is used in the example below.

| Ingredient | | Concentration |
|---|---|---|
| Part A | Palatinose | 26.53% |
| | 42DE Glucose Syrup | 8.99% |
| | Polydextrose | 16.70% |
| | Water | 4.45% |
| Part B | Collagen | 18.55% |
| | BODYBALANCE | |
| | Water | 11.41% |
| Part C | Gelatine | 5.66% |
| | Water | 7.42% |
| Part D | Citric Acid | 3.0% (over total) |
| | Colours and Flavours | 0.43% (over total) |

Method:

Disperse collagen in water and allow to heat and dissolve at 70° C. Part B

Dissolve gelatine in water at 60° C. Part C

Palatinose, Glucose syrup, polydextrose and water (Part A) heated to 118° C. (approximately 86% solids)

Allow Sugar syrup to cool to 100° C. and then incorporate gelatine and collagen solutions into the syrup.

Once syrup is below 80° C. add colours, flavours and lastly acid. (Part D)

Deposit into moulds and allow to set at ambient temperature for a minimum of 4 hours.

Demould product and coat in confectioners glaze/oil to prevent sticking.

Total Depositing Solids 76-82%

### Example 8

A further protein “marshmallow” style bar is to have a minimum of 15 g daily serving of bioactive collagen peptides with up to 40 g of protein in total, further nutritional requirements are to include no more than 5 grams of carbohydrates and 2 grams or less of sugar per serve.

### Product 1—Marshmallow Bar

| Component | INGREDIENT | % |
|---|---|---|
| Part A | Erythritol | 10.70% |
| | Water (4) | 5.58% |
| | Polydextrose (4) | 12.65% |
| Part B | Water (3) | 9.42% |
| | Gelatine (3) | 9.09% |
| Part C | Gelita Hydrolysed Collagen (1) | 38.92% |
| | Water (1) | 10.51% |
| Part D | Stevia | 0.05% |
| | Tryptophan | 0.16% |
| | Cultured Dextrose | 1.95% |
| | Flavour Vanilla | 0.97% |

### Process

1. Mix part C together and heat to 70° C., hold at this temperature. Mix Part A together and cook to specific solids (approximately 118° C.). Add part B to part A and stir until gelatine has dissolved. Add part A and B to part C mixture and mix well. Add in components of part D and incorporate well, once incorporated aerate the mixture to a specific gravity/density of 0.5-0.7. Keep the mixture at around 70° C. in a hopper or holding tank until ready to deposit.
2. Deposit the syrup into oiled silicone or plastic moulds. Dry the bars at room temperature for 1-2hrs, remove bars from moulds and pack.

### Nutritional Panel

| | Per 100 grams | Per 45 g |
|---|---|---|
| Energy (Calories) | 221.73 | 99.78 |
| Energy (KJ) | 927.69 | 417.46 |
| Protein (g) | 47.24 | 21.26 |
| Fats Total (g) | 0.00 | 0.00 |
| Fats Saturated (g) | 0.00 | 0.00 |
| Carbs (g) | 2.04 | 0.92 |
| Sugar (g) | 0.00 | 0.00 |
| Dietary Fibre (g) | 11.60 | 5.22 |
| Sodium (mg) | 96.25 | 43.31 |

### Example 9

A further protein “gummy/jelly” style bar is to have a minimum of 15 g daily serving of bioactive collagen peptides with up to about 40 g of protein in total, further nutritional requirements are to include no more than 5 grams of carbohydrates and 2 grams or less of sugar per serve.

### Product—Gummy Style Bar

| Component | INGREDIENT | % |
|---|---|---|
| Part A | Water (2) | 8.99% |
| | Agar (2) | 0.59% |
| Part B | Erythritol | 7.72% |
| | Water (4) | 4.37% |
| | Polydextrose (4) | 13.65% |
| Part C | Water (3) | 7.15% |
| | Gelatine (3) | 6.50% |
| Part D | Gelita Hydrolysed Collagen (1) | 31.21% |
| | Water (1) | 8.45% |
| Part E | Stevia | 0.06% |
| | Tryptophan | 0.14% |
| | Cultured Dextrose | 1.63% |
| | Coconut Milk Powder | 8.78% |
| | Banana Flavour | 0.25% |
| | Caramel Flavour | 0.25% |
| | Brown Powder Colour | 0.25% |

### Process

1. Mix part D together and heat to 70° C., hold at this temperature. Cook part A to boiling and hold for 1 minute, once partially thickened add part B and mix well and cook until desired total solids are reached. Add part C to part A and B and stir until gelatine has dissolved. Add parts A and B and C to D mixture and stir well. Add in components of part E and incorporate well, once incorporated deaerate the mixture until solution is clear. Keep the mixture at around 70° C. in a hopper or holding tank until ready to deposit.
2. Deposit the syrup into oiled silicone or plastic moulds. Dry the bars at room temperature for 1-2 hrs, remove bars from moulds and pack.

### Nutritional Panel

| | Per 100 grams | Per 65 g |
|---|---|---|
| Energy (Calories) | 278.85 | 181.25 |
| Energy (KJ) | 1166.71 | 758.36 |
| Protein (g) | 43.72 | 28.42 |
| Fats Total (g) | 6.47 | 4.20 |
| Fats Saturated (g) | 5.92 | 3.85 |
| Carbs (g) | 5.28 | 3.43 |
| Sugar (g) | 2.16 | 1.41 |
| Dietary Fibre (g) | 14.40 | 9.36 |
| Sodium (mg) | 117.10 | 76.11 |

### Example 10

A further ketogenic protein bar is embodied below, which provides a source of calories from the below listed macronutrients for a ketogenic diet:
Calories from carbohydrates: 5-10%, equating to 8.4%-13.8% of total product by weight
Calories from Protein: 30-35%, equating to 48.3%-50.5% of total product by weight
Calories from Fat: 55-60%, equating to 37.8%-41.1% of total product by weight

The below link (which is incorporated by reference herein) explains how a ketogenic diet provides support for these parameters: https://www.ncbi.nlm.gov/books/NBK499830/.

### Recipe

| Component | Ingredient | % Input |
|---|---|---|
| Part A | Agar | 0.43% |
| | Water | 13.03% |
| Part B | Erythritol | 8.60% |
| | Polydextrose | 13.03% |
| | Water | 2.17% |
| Part C | Gelatine | 4.34% |
| | Water | 2.17% |
| Part D | Collagen | 30.39% |
| | Water | 10.85% |
| Part E | Stevia | 0.07% |
| | Tryptophan | 0.16% |
| | Flavour | 0.65% |
| | Cultured Dextrose | 2.17% |
| | Coconut Milk Powder | 8.47% |
| | MCT Oil | 3.47% |

### Nutritional Panel

| | Per 100 grams | Per 65 g |
|---|---|---|
| Energy (Calories) | 428.60 | 278.59 |
| Energy (KJ) | 1759.03 | 1143.37 |
| Protein (g) | 39.97 | 25.98 |
| Fats Total (g) | 27.91 | 18.14 |
| Fats Saturated (g) | 27.33 | 17.76 |
| Carbs (g) | 4.38 | 2.85 |
| Sugar (g) | 1.86 | 1.21 |
| Dietary Fibre (g) | 13.37 | 8.69 |
| Sodium (mg) | 92.18 | 59.92 |

### Example 11

A further low sugar confectionery base is used in the example below.

| Ingredient | | Concentration |
|---|---|---|
| Part A | Sugar | 11.37% |
| | 42DE Glucose Syrup | 9.39% |
| | Polydextrose | 12.68% |
| | Water | 9.39% |
| | Erythritol | 9.39% |
| Part B | Collagen | 18.79% |
| | BODYBALANCE | |
| | Water | 11.56% |
| Part C | Gelatine | 6.67% |
| | Water | 7.52% |
| Part D | Citric Acid | 2.82% |
| | Colours and Flavours | 0.42% |

Method:

Disperse collagen in water and allow to heat and dissolve at 70° C. Part B

Dissolve gelatine in water at 60° C. Part C

Sugar, Glucose syrup, polydextrose, erythritol and water (Part A) heated to 118° C. (approximately 86% solids)

Allow Sugar syrup to cool to 100° C. and then incorporate gelatine and collagen solutions into the syrup.

Once syrup is below 80° C. add colours, flavours and lastly acid. (Part D)

Deposit into moulds and allow to set at ambient temperature for a minimum of 4 hours.

Demould product and coat in confectioners glaze/oil to prevent sticking.

Total Depositing Solids 76-82%

### Nutrition Panel

| | Per 100 grams | Per 65 g |
|---|---|---|
| Energy (Calories) | 197.61 | 128.45 |
| Energy (KJ) | 826.78 | 537.41 |
| Protein (g) | 26.55 | 17.26 |
| Fats Total (g) | 0.00 | 0.00 |
| Fats Saturated (g) | 0.00 | 0.00 |
| Carbs (g) | 20.77 | 13.50 |
| Sugar (g) | 15.14 | 9.84 |
| Dietary Fibre (g) | 12.34 | 8.02 |
| Sodium (mg) | 47.74 | 31.03 |

It will therefore be appreciated from the foregoing that the invention provides a protein food product and gummy composition that provides an optimal source of protein, while also having a pleasant taste and texture and a relatively low level of lipids and carbohydrates.

Throughout this specification, the aim has been to describe the preferred embodiments of the invention without limiting the invention to any one embodiment or specific collection of features. Various changes and modifications may be made to the embodiments described and illustrated herein without departing from the broad spirit and scope of the invention.

All patent, technical and scientific literature referred to herein is incorporated herein by reference in their entireties.

1. A protein food product comprising:
protein that optionally includes collagen protein, peptides and/or one or more amino acids or derivatives thereof;
one or more gelling agents; and
optionally one or more flavouring agents and/or one or more sweetening agents,
wherein the total protein content of the protein food product is at least about 8% by weight and the total lipid content is less than about 60% by weight of the protein food product.

2. The protein food product of claim 1, wherein the protein that includes collagen protein, peptides or derivatives thereof comprises a collagen hydrolysate.

3. The protein food product of claim 1, wherein the gelling agent is selected from the group consisting of alginate, pectin, carrageenan, gelatine, gellan, agar and any combination thereof.

4. The protein food product of claim 1, wherein the one or more sweetening agents comprise erythritol and/or stevia.

5. The protein food product of claim 1, which further comprises one or more humectants, one or more colouring agents, one or more pH modifiers and/or one or more vitamins and/or minerals.

6. The protein food product of claim 5, wherein the pH modifiers comprise an organic acid, such as malic acid, citric acid and/or ascorbic acid.

7. The protein food product of claim 1, wherein the gelling agent is, or comprises, gelatine.

8. The protein food product of claim 5, wherein the humectant is or comprises glycerine.

9. The protein food product of claim 1, wherein the total carbohydrate content is less than about 70% by weight of the protein food product.

10. The protein food product of any one of claim 1, wherein the total lipid content is less than about 10% by weight of the protein food product.

11. The protein food product of claim 10, which comprises substantially no lipid.

12. The protein food product of claim 1, wherein the total lipid content is between about 10% to about 50% by weight of the protein food product.

13. The protein food product of claim 12, wherein the protein food product promotes, enhances and/or prolongs ketosis in a subject.

14. The protein food product of claim 1, which is in the form of a gummy composition.

15. The protein product of claim 1, which has a specific gravity/density of about 1.2 to 1.6.

16. A method of producing a protein food product including the steps of:
(a) combining:
protein that optionally includes collagen protein, peptides and/or one or more amino acids or derivatives thereof;
one or more gelling agents; and
optionally one or more flavouring agents and/or one or more sweetening agents; and
(b) forming the protein food product, wherein the total protein content of the protein food product is at least about 8% by weight and the total lipid content is less than about 60% by weight of the protein food product.

17. The method of claim 16, further including combining one or more humectants, one or more colouring agents, one or more pH modifiers and/or one or more vitamins and/or minerals.

18. The method of claim 16, further including the step of forming the protein food product in a mould.

19. A method for providing nutritional supplementation to a subject, comprising:
administering to the subject an effective amount of a protein food product, said protein food product comprising:
protein that optionally includes collagen protein, peptides and/or one or more amino acids or derivatives thereof;
one or more gelling agents; and
optionally one or more flavouring agents and/or one or more sweetening agents
wherein the total protein content of the protein food product is at least about 8% by weight and the total lipid content is less than about 60% by weight of the protein food product.

20. A method of promoting, enhancing and/or prolonging ketosis in a subject, comprising:
administering to the subject an effective amount of a protein food product, said protein food product comprising:
protein that optionally includes collagen protein, peptides and/or one or more amino acids or derivatives thereof;
one or more gelling agents; and
optionally one or more flavouring agents and/or one or more sweetening agents wherein the total protein content of the protein food product is at least about 8% by weight and the total lipid content is less than about 60% by weight of the protein food product.
